(19) United States
(12) Patent Application Publication
(10) Pub. No.: US 2015/0353797 A1
(43) Pub. Date: Dec. 10, 2015

(54) LIQUID-APPLIED WATERPROOFING MEMBRANE FOR ROOFS

(71) Applicant: SIKA TECHNOLOGY AG, Baar (CH)

(72) Inventors: Stefan KISLIG, Suzhou (CN); Marc BALMER, Unterengstringen (CH)

(73) Assignee: SIKA TECHNOLOGY AG, Baar OT (CH)

(21) Appl. No.: 14/762,429

(22) PCT Filed: Jan. 21, 2014
(86) PCT No.: PCT/EP2014/051134

§ 371 Date: Jul. 21, 2015

(30) Foreign Application Priority Data
Jan. 22, 2013 (EP) 13152260.9

(51) Int. Cl. C09K 3/18; C08K 5/3435; C08K 3/26; C08K 9/04; E04D 7/00; C09D 175/08

(52) U.S. Cl. CPC C09K 3/18; E04D 7/00; C09D 175/08; C08K 3/26; C08K 9/04; C08K 5/3435

(57) ABSTRACT

The present invention describes a one-part moisture-curing liquid applied waterproofing membrane comprising an MDI-based polyurethane polymer and two different aldimines as blocked amine hardeners in a specific ratio range. The membrane has a low odour, a long shelf life stability, a low viscosity at low solvent content, a sufficiently long open time to allow hand application and cures fast to a solid elastic material. The liquid-applied waterproofing membrane is particularly suitable for roofing applications, possessing high strength, high elongation and good durability under outdoor wheathering conditions in a broad temperature range.

### FIELD OF THE INVENTION

The invention relates to a liquid-applied waterproofing membrane based on one-part moisture-curing polyurethane, particularly for roofing applications.

### BACKGROUND OF THE INVENTION

Liquid-applied waterproofing membranes are known. In roofing applications they are used as an alternative to prefabricated sheet membranes, offering easier application especially in the case of complex roof geometries and for refurbishment tasks, providing a flexible seamless roof coating which is fully adhered to the substrate.

Liquid-applied waterproofing membranes on roofs have to fulfill demanding requirements. They need to have a low viscosity to be applied as self-levelling coatings and a sufficiently long open time to enable hand application, but still cure fast in order to quickly lose their vulnerability. When fully cured the roofing membrane needs to have durable elasticity and strength in order to protect the building effectively from water ingress in a broad temperature range and under outdoor weathering conditions, such as wind forces, ponding water, frost, strong sunlight irradiation, microbial attack and root penetration.

State-of-the-art liquid-applied waterproofing membranes are often reactive polyurethane compositions, formulated as one-part or as two-part systems, also called single-component or two-component systems, respectively. Two-part systems are more complex to apply, requiring special mixing equipment and proper metering of the two components, since mistakes in mixing quality and/or stoichiometry strongly affect the membrane performance. One-part systems are easy to apply, but prone to curing defects. State-of-the-art one-part systems comprise blocked amine hardeners, in particular oxazolidines, to prevent excessive gassing from carbon dioxide formation on curing. They generally contain considerable amounts of solvents to guarantee low viscosity and sufficient shelf life. Attempts spurred by tightening VOC regulation to reduce the solvent content of such one-part systems typically result in difficulties with shelf life stability and bad workability because of high viscosity, as the viscosity of the compositions starts on a higher level and increases further from premature crosslinking reactions between the isocyanate groups of the prepolymer and the oxazolidine hardeners during storage. Further drawbacks of oxazolidine-based one-part membranes are related to slow curing and unpleasant odours caused by the emission of the blocking agent, a volatile aldehyde or ketone. Among the commercial isocyanates, MDI is the most interesting to use from a health and safety point of view, since it is of very low volatility. Moreover MDI is relatively inexpensive and affords fast curing properties and high mechanical strength. However, the use of MDI in state-of-the-art one-part waterproofing membranes typically lead to problems related to shelf life stability and working properties.

WO 2004/013200 discloses MDI-based one component compositions comprising aldol ester polyaldimines as blocked amine hardeners. While these compositions have good shelf life stability and cure without generating unpleasant odours, they are much too high in viscosity to be suitable as liquid applied waterproofing membranes, and common methods to reduce viscosity such as addition of plasticizer are limited in order not to reduce hardness and durability of the material.

WO 2008/000831 discloses low VOC coating compositions, preferably for flooring purposes, which are based on aldol ester polyaldimines as blocked amine hardeners. The compositions are based on aliphatic isocyanates containing highly volatile isocyanates. Moreover, the revealed coatings are not suitable as low-VOC liquid applied membranes for roofing applications, particularly regarding flexibility and/or VOC content.

### SUMMARY OF THE INVENTION

The task of this invention is to provide a one-part liquid-applied waterproofing membrane based on methylene diphenyl diisocyanate (MDI) useful for roofing applications having good shelf life stability and good workability at low solvent content, even when containing less than 200 g VOC per liter, as well as fast and reliable curing properties.

Surprisingly it was found that the waterproofing membrane according to Claim 1 fulfills this task and has additional benefits. It comprises an isocyanate-functional polyurethane polymer based on MDI and polyether polyol, providing good tensile strength and high elongation almost independent of temperature, remaining elastic also under cold climate conditions. It further comprises a combination of two different aldol ester aldimines in a specific ratio range. This combination surprisingly affords a very attractive set of properties not reached by state-of-the-art membranes: a very good shelf life stability, a low viscosity even at low solvent content, good mechanical properties, in particular high strength in conjunction with high elongation in a broad temperature range, long open time allowing hand application yet fast and reliable curing properties preventing defects. Outside of the claimed range of the aldimine ratio, the membrane either shows insufficient cure speed or insufficient elongation. The two aldimines within the claimed ratio range enable to balance viscosity, mechanical properties and cure speed of the membrane. With the liquid-applied membrane of Claim 1 it is, for example, possible to fulfill the requirements of the Japanese standard JIS-6021 for waterproofing membranes.

The liquid-applied membrane according to Claim 1 affords an inexpensive high-end product fulfilling tough VOC regulations, having minimal shrinkage and a very low odour profile. It has a sufficiently long open time to allow hand application, yet cures fast to develop high early strength, thus minimizing the time in which the membrane is vulnerable and speeding up the application in case of a multi-layer build-up. The good mechanical properties afford high crack-bridging qualities in a broad temperature range and ensure a high durability.

The liquid-applied membrane according to Claim 1 is particularly suitable for use on a roof, particularly on a flat or low slope roof. It is particularly advantageous for detailing work and for refurbishment purposes.

Other aspects of the invention are revealed in other independent claims. Preferred aspects of the invention are revealed in the dependent claims.

### DETAILED DESCRIPTION OF THE INVENTION

The subject of the present invention is a one-part moisture-curing liquid-applied waterproofing membrane comprising
at least one isocyanate-functional polyurethane polymer obtained from at least one polyether polyol and methylene diphenyl diisocyanate (MDI);
at least one aldimine of the formula (I); and
at least one aldimine of the formula (II),

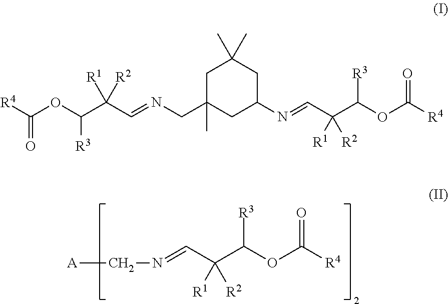

wherein
R¹ and R² are the same or different C₁ to C₁₂ linear or branched alkyls, or are joined together to form a divalent linear or branched C₄ to C₁₂ hydrocarbyl moiety which is part of a 5- to 8-membered carbocyclic ring,
R³ is hydrogen or a linear or branched C₁ to C₁₂ alkyl or arylalkyl or alkoxycarbonyl,
R⁴ is a monovalent C₆ to C₂₀ hydrocarbyl moiety optionally containing ether, carbonyl or ester groups, and
A is nil or a divalent hydrocarbyl moiety of a molecular weight in the range of 14 to 140 g/mol;
   whereby the molar ratio between the aldimine of the formula (I) and the aldimine of the formula (II) is in the range of 90/10 to 60/40.

In this document, the term “one-part moisture-curing” refers to a liquid-applied membrane, which is contained in a single moisture-tight container, has a certain shelf life stability and cures when exposed to moisture.

In this document the term “liquid-applied waterproofing membrane” refers to a material which is applied in liquid form as a layer onto a substrate, and which cures to form an elastic membrane making the substrate waterproof.

In this document, the term “polyurethane polymer” includes all polymers prepared by the so-called diisocyanate polyaddition process. It includes isocyanate-functional polyurethane polymers obtained by reacting polyisocyanates and polyols, which may also be called prepolymers and are polyisocyanates themselves.

In this document the acronym “MDI” stands for the chemical substance “methylene diphenyl diisocyanate”. The term includes any isomeric forms of MDI and any mixtures thereof, particularly 4,4′-diphenylmethane-diisocyanate, 2,4′-diphenylmethane-diisocyanate and 2,2′-diphenylmethane-diisocyanate.

In this document, the term “shelf life stability” refers to the ability of a composition to be stored at room temperature in a suitable container under exclusion of moisture for a certain time interval, in particular several months, without undergoing significant changes in application or end-use properties.

In this document, substance names starting with “poly”, such as polyol, polyisocyanate or polyamine, refer to substances carrying two or more of the respective functional groups (e.g. OH groups in the case of polyol) per molecule. In this document an amine or an isocyanate is called “aliphatic” when its amino group or its isocyanate group, respectively, is directly bound to an aliphatic, cycloaliphatic or arylaliphatic moiety. The corresponding functional group is therefore called an aliphatic amino or an aliphatic isocyanate group, respectively.

In this document an amine or an isocyanate is called “aromatic” when its amino group or its isocyanate group, respectively, is directly bound to an aromatic moiety. The corresponding functional group is therefore called an aromatic amino or an aromatic isocyanate group, respectively.

In this document, the term “primary amino group” refers to an NH₂-group bound to an organic moiety, and the term “secondary amino group” refers to a NH-group bound to two organic moieties which together may be part of a ring. In this document the acronym “VOC” stands for “volatile organic compounds”, which are organic substances having a vapour pressure of at least 0.01 kPa at a temperature of 293.14 K.

In this document, the term “solvent” refers to a liquid which is a VOC, which is able to dissolve isocyanate-functional polyurethane polymers as described in this document, and which does not carry any isocyanate-reactive functional groups.

In this document, “room temperature” refers to a temperature of 23° C. In this document the term “molecular weight” refers to the molar mass (given in grams per mole) of a molecule or a part of a molecule, also referred to as “moiety”. The term “average molecular weight” refers to the number-average molecular weight (Mₙ) of an oligomeric or polymeric mixture of molecules or moieties.

The liquid applied membrane of this invention comprises at least one isocyanate-functional polyurethane polymer obtained from at least one polyether polyol and MDI, whereby the isocyanate groups of MDI are in stoichiometric excess over all the hydroxyl groups. The MDI and the polyol are brought to reaction via known methods, preferably at temperatures between 50 and 100° C., optionally by using a suitable catalyst. Preferably the MDI is used in an amount corresponding to an isocyanate to hydroxyl group ratio in the range of 1.3 to 5, more preferably 1.5 to 3, particularly 1.8 to 2.8.

Optionally the polyol and the MDI may be reacted in the presence of a plasticizer or a solvent which are free from isocyanate-reactive groups.

Preferably the polyurethane polymer has a free isocyanate group content of below 5 weight-%, particularly in the range of 2 to 4.5 weight-%.

Such a polyurethane polymer enables low viscosity and good mechanical properties, particularly high elongation.

Preferably the isocyanate-functional polyurethane polymer has an average molecular weight in the range of 1'000 to 20'000 g/mol, more preferably in the range of 2'000 to 10'000 g/mol.

Preferably the isocyanate-functional polyurethane polymer has an average isocyanate functionality in the range of 1.7 to 3, more preferably 1.8 to 2.5. Such a polyurethane polymer enables low viscosity and good mechanical properties.

Preferred polyether polyols for obtaining the isocyanate-functional polyurethane polymer are polyoxyalkylenepolyols. These polyols help to develop good low temperature flexibility in the cured membrane.

Polyoxyalkylenepolyols are products of the polymerziation of ethylene oxide, 1,2-propylene oxide, 1,2- or 2,3-butylene oxide, oxetane, tetrahydrofuran or mixtures thereof, optionally polymerized using a starter molecule with two or more active hydrogen atoms, such as water, ammonia or compounds with several OH- or NH-groups such as 1,2-ethanediol, 1,2- and 1,3-propanediol, neopentylglycol, diethyleneglycol, triethyleneglycol, the isomeric dipropyleneglycols and tripropyleneglycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, as well as mixtures of the above-mentioned compounds.

Preferred are both polyoxyalkylenepolyols with a low degree of unsaturation (measured according to ASTM D-2849-69 and indicated in milliequivalents of unsaturation per gram of polyol (meq/g)), obtainable, for example, using so-called double metal cyanide complex catalysts (DMC Catalysts), and polyoxyalkylenepolyols with a higher degree of unsaturation, obtainable, for example, using anionic catalysts such as NaOH, KOH, CsOH or alkali alcoholates.

A particularly preferred polyether polyol is a polymerization product of ethylene oxide and/or propylene oxide, particularly a polyoxypropylenepolyol or an ethylene oxide endcapped polyoxypropylenepolyol. The latter is a specific polyoxypropylene-polyoxyethylenepolyol obtainable by post-ethoxylating a pure polyoxypropylenepolyol, thus featuring primary hydroxyl groups. These polyols enable good low temperature flexibility and good weathering properties in the cured membrane.

Most preferred polyether polyols are polyoxypropylenediols and -triols and ethylene oxide endcapped polyoxypropylenediols and -triols with an average molecular weight in the range of 500 to 10'000 g/mol, particularly in the range of 1'000 to 6'000 g/mol.

These polyether polyols provide a combination of low viscosity, good weathering properties and good mechanical properties in the cured membrane.

In a preferred embodiment, the isocyanate-functional polyurethane polymer is obtained from a combination of at least two different polyether polyols, in particular from at least one polyether diol and at least one polyether triol. Such a polyurethane polymer enables membranes with high elongation at high strength and good durability.

Along with the above-mentioned polyether polyols, other polyols can be used, in particular
polyether polyols containing dispersed styrene-acrylonitrile (SAN) or acrylonitrile-methylmethacrylate or urea particles;
polyester polyols such as products of the polycondensation reaction of diols or triols with lactones or dicarboxylic acids or their esters or anhydrides;
polycarbonate polyols, particularly products of the polycondensation of dialkyl carbonates, diaryl carbonates or phosgene with diols or triols such as ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-octadecanediol, 1,4-cyclohexane dimethanol, dimeric fatty acid diol (dimeryl diol), hydroxypivalic neopentylglycol ester, glycerol and 1,1,1-trimethylolpropane;
block copolymer polyols with at least two different blocks of polyether, polyester or polycarbonate units;
polyacrylate and polymethacrylate polyols;
polyhydroxy-functional fats and oils, especially natural fats and oils; and
polyhydrocarbon polyols, such as polyhydroxy-functional polyolefins.
   From these other polyols, the polycarbonate polyols are preferred, as they can help to develop good weathering properties of the membrane.

Along with the above-mentioned polyols, small amounts of low molecular weight divalent or multivalent alcohols can be used, such as 1,2-ethanediol, 1,2-propanediol, neopentyl glycol, dibromoneopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexane dimethanol, hydrogenated bisphenol A, dimer fatty alcohols, 1,1,1-trimethylolethane, 1,1,1-trimethylolpropane, glycerol, pentaerythritol, sugar alcohols, such as xylitol, sorbitol or mannitol, sugars, such as saccharose, other polyhydric alcohols, low molecular weight alkoxylation products of the above-mentioned divalent or multivalent alcohols, as well as mixtures of the above-mentioned alcohols.

Preferred low molecular weight alcohols are difunctional alcohols with a molecular weight in the range of 60 to 150 g/mol. Particularly preferred are 1,2-ethanediol, 1,3-propanediol, 1,4-butanediol, 1,5-pentanediol, 1,6-hexanediol, 1,3-cyclohexane dimethanol, 1,4-cyclohexane dimethanol and diethylene glycol. These alcohols improve particularly the strength of the membrane. Most preferred is 1,4-butanediol.

Further preferred low molecular weight alcohols are difunctional bromated alcohols such as dibromoneopentyl glycol. These alcohols improve particularly the flame retarding properties of the membrane.

Preferably the polyol mixture to obtain the isocyanate-functional polyurethane polymer contains at least 50 weight-%, more preferably at least 80 weight-%, particularly at least 90 weight-%, of polyether polyols. Such a polyurethane polymer has a low viscosity and enables a high flexibility at low temperatures.

Suitable forms of methylene diphenyl diisocyanate (MDI) to obtain the isocyanate-functional polyurethane polymer are 4,4′-diphenylmethane diisocyanate, 2,4′-diphenylmethane diisocyanate and 2,2′-diphenylmethane diisocyanate and any mixtures of these isomers, as well as mixtures of MDI with oligomers or polymers or derivatives of MDI, preferably so-called modified MDI containing carbodiimides or uretonimines or urethanes of MDI, which are commercially available e.g. as Desmodur® CD, Desmodur® PF, Desmodur® PC (all from Bayer) or Isonate® M 143 (from Dow), as well as so-called polymeric MDI or PMDI representing mixtures of MDI with homologues of MDI, commercially available e.g. as Desmodur® VL, Desmodur® VL50, Desmodur® VL R10, Desmodur® VL R20, Desmodur® VH 20 N and Desmodur® VKS 20F (all from Bayer), Isonate® M 309, Voranate® M 229 and Voranate® M 580 (all from Dow) or Lupranate® MI (from BASF).

Particularly preferred forms of MDI are 4,4′-diphenylmethane diisocyanate and 2,4′-diphenylmethane diisocyanate, as well as mixtures comprising 4,4′-diphenylmethane diisocyanate and 2,4′-diphenylmethane diisocyanate in about equal amounts, commercially available e.g. as Desmodur® 2424 (from Bayer) or Lupranate® MI (from BASF).

The one-part moisture-curing liquid applied waterproofing membrane further comprises at least one aldimine of the formula (I).

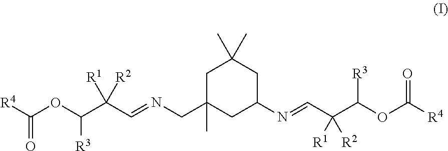

Preferably R¹ and R² are each methyl. These aldimines provide membranes having low viscosity as well as fast, reliable curing properties.

Preferably R³ is hydrogen. These aldimines provide membranes having low viscosity as well as fast, reliable curing properties.

Preferably R⁴ is C₁₁ alkyl. They provide odourless membranes having low viscosity and high flexibility at low temperatures.

A particularly preferred aldimine of the formula (I) is N,N′-bis(2,2-dimethyl-3-lauroyloxypropylidene)-3-aminomethyl-3,5,5-trimethylcyclohexylamine. It provides odourless membranes having a very good shelf life stability, low viscosity, fast and reliable curing properties and a particularly high elongation.

The one-part moisture-curing liquid applied waterproofing membrane further comprises at least one aldimine of the formula (II).

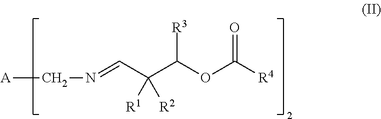

Preferably R¹ and R² are each methyl. These aldimines provide membranes having low viscosity as well as fast, reliable curing properties.

Preferably R³ is hydrogen. These aldimines provide membranes having low viscosity as well as fast, reliable curing properties.

Preferably R⁴ is C₁₁ alkyl. They provide odourless membranes having low viscosity and high flexibility at low temperatures.

Preferably A is an 1,4-butylene or an 1,3-cyclohexylene or an 1,3-phenylene group.

Particularly preferred aldimines of the formula (II) are derived from hexamethylene-1,6-diamine, 1,3-bis(aminomethyl)cyclohexane and 1,3-bis(aminomethyl)benzene. They provide membranes having low viscosity, a particularly high cure speed and a very high elongation.

A particularly preferred aldimine of the formula (II) is N,N′-bis(2,2-dimethyl-3-lauroyloxypropylidene)-hexamethylene-1,6-diamine. It provides odourless membranes having a very good shelf life stability, very low viscosity, a particularly high cure speed, high elongation and very high strength.

In a particularly preferred embodiment of the invention the substituents R¹, R² and R³ in the formula (I) are the same as in the formula (II).

The aldimines of the formula (I) and (II) are preferably available from a condensation reaction of at least one primary amine and at least one aldehyde of the formula (IV). In the case of the aldimine of the formula (I) the primary amine is 3-aminomethyl-3,5,5-trimethylcyclohexylamine (isophoronediamine), and in the case of the aldimine of the formula (II) the primary amine is an amine of the formula (III).

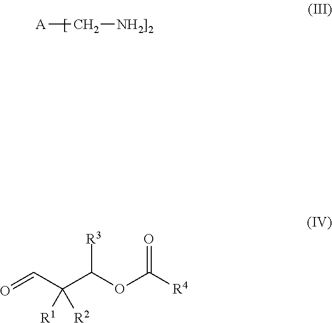

In the formula (III) and (IV), A, R¹, R², R³ and R⁴ have the already mentioned meanings.

For this condensation reaction, the aldehyde of the formula (IV) is used stochiometrically or in excess related to the primary amino groups of the primary amine. The reaction can advantageously be conducted at a temperature in the range between 15 and 120° C., either in the presence of a solvent or without a solvent. The released water is being removed either azeotropically with a suitable solvent, or directly under vacuum.

Particularly suitable amines of the formula (III) are ethylene diamine, propylene-1,3-diamine, 2-methylpropylene-1,3-diamine, 2,2-dimethylpropylene-1,3-diamine, butylene-1,4-diamine, 2-methylbutylene-1,4-diamine, pentamethylene-1,5-diamine, 2-methylpentane-1,5-diamine, hexamethylene-1,6-diamine, 2,2,4- and 2,4,4-trimethylhexamethylene-1,6-diamine, heptamethylene-1,7-diamine, nonamethylene-1,9-diamine, decamethylene-1,10-diamine, undecamethylene-1,11-diamine, dodecamethylene-1,12-diamine, 1,3-bis-(aminomethyl)cyclohexane, 1,4-bis-(aminomethyl)cyclohexane, 2,5(2,6)-bis-(aminomethyl)bicyclo[2.2.1]heptane, 1,3-bis-(aminomethyl)benzene and 1,4-bis(aminomethyl)benzene.

Preferred thereof are hexamethylene-1,6-diamine, 1,3-bis-(aminomethyl)cyclohexane and 1,3-bis-(aminomethyl)benzene.

Particularly preferred is hexamethylene-1,6-diamine.

In the liquid applied membrane, the molar ratio between the aldimine of the formula (I) and the aldimine of the formula (II) is in the range of 90/10 to 60/40.

In this range, the membrane is fast curing, featuring high elongation also at subzero temperatures and high strength also at elevated temperatures.

At a molar ratio above 90/10, the membrane is too soft, has insufficient tensile strength and cure speed, so that the membrane remains vulnerable for a long time after application.

At a molar ratio below 60/40, the membrane has insufficient elongation. Preferably the molar ratio between the aldimine of the formula (I) and the aldimine of the formula (II) is in the range of 85/15 to 60/40. In this range, the membrane is fast curing and has high elongation at high strength. Such a molar ratio enables membranes with fast curing properties and good mechanical properties both at low and at high temperatures, particularly in the temperature range of −20° C. to 60° C., particularly the mechanical properties which are needed to fulfill the Japanese standard JIS-6021 for roofing membranes.

Preferably the aldimine content in the liquid applied membrane is such that the ratio between the total number of aldimino groups to the number of isocyanate groups is in the range of 0.3 to 1.0, preferably 0.4 to 0.9, more preferably 0.6 to 0.8. In this range, the membrane cures quickly without the formation of bubbles or blisters to a flexible material of high strength.

Preferably the content of the isocyanate-functional polyurethane polymer in the liquid applied membrane is in the range of 15 to 70 weight-%, more preferably 15 to 60 weight-%, particularly 15 to 50 weight-%. This enables membranes with good durability and good mechanical properties.

Besides the ingredients already mentioned, the liquid applied membrane may comprise further ingredients.

Preferably the liquid applied membrane comprises at least one filler. Fillers help to develop strength and durability.

Preferred fillers are inorganic fillers, particularly calcium carbonate (“chalk”), such as ground calcium carbonate (GCC) and precipitated calcium carbonate (PCC), barium sulfate (barytes), slate, silicates (quartz), magnesiosilicates (talc), alumosilicates (clay, kaolin), dolomite, mica, glass bubbles and silicic acid, in particular highly dispersed silicic acids from pyrolytic processes (fumed silica). These fillers may or may not carry a surface coating, e.g. a stearate or siloxane coating.

Further preferred fillers are organic fillers, particularly carbon black and microspheres.

Preferably the liquid applied membrane further comprises at least one pigment. The pigment defines the colour of the membrane, helps to develop strength and increases durability, particularly UV-stability.

Preferred pigments are titanium dioxide, iron oxides and carbon black.

Preferably the liquid applied membrane further comprises at least one flame-retarding filler. Preferred flame-retarding fillers are aluminum trihydroxide (ATH), magnesium dihydroxide, antimony trioxide, antimony pentoxide, boric acid, zinc borate, zinc phosphate, melamine borate, melamine cyanurate, ethylenediamine phosphate, ammonium polyphosphate, di-melamine orthophosphate, di-melamine pyrophosphate, hexabromocyclododecane, decabromodiphenyl oxide and tris(bromoneopentyl)phosphate.

Preferably the liquid applied membrane further comprises at least one plasticizer, particularly a phthalate such as diisodecylphtalate or diisononylphtalate, a trimellitate, a succinate, a glutarate, an adipate, a sebacate, an azelate, a citrate, a benzoate, an acetylated glycerin or monoglyceride, a hydrogenated phthalate, a fatty acid ester, an arylsulfonate or hydrocarbon resins, or a so called flame-retarding plasticizer, particularly a phosphate or a phosphonate, particularly triphenyl phosphate (TPP), diphenyl-tert.butylphenyl phosphate, diphenylcresyl phosphate (DPK), tricresyl phosphate (TKP), triethyl phosphate, tris(2-ethylhexyl)phosphate, diphenyl-2-ethylhexyl phosphate (DPO), tris(2-ethylhexyl)phosphate (TOF), diphenylisodecyl phosphate, dimethyl propane phosphonate (DMPP), tetraphenyl resorcinol diphosphate, resorcinol diphosphate oligomer (RDP), ethylenediamine diphosphate, as well as chloroalkyl phosphate esters such as tris(1-chloro-2-propyl)phosphate, tris(1,3-dichloro-2-propyl)phosphate and 2,2-bis(chloromethyl)trimethylene bis(bis(2-chloroethyl)-phosphate).

Preferably the liquid applied membrane further comprises at least one acid catalyst accelerating the hydrolysis of the aldimino groups. Preferred acid catalysts are carboxylic acids and sulfonic acids, particularly aromatic carboxylic acids, such as benzoic acid or salicylic acid.

Preferably the liquid applied membrane further comprises at least one UV-stabilizer. Preferred UV-stabilizers are UV-absorbers, such as benzophenones, benzotriazoles, oxalanilides, phenyltriazines and particularly 2-cyano-3,3-diphenylacrylic acid ethyl ester, and hindered amine light stabilizers (HALS), such as bis(1,2,2,6,6-pentamethyl-4-piperidyl) sebacate and other compounds containing at least one 1,2,2,6,6-pentamethyl-4-piperidinyl moiety. UV-stabilizers help to prevent the polymer from degradation under light exposure.

The liquid applied membrane may further comprise the following ingredients:
polyisocyanate crosslinkers, particularly the already mentioned oligomers, polymers or derivatives of MDI; HDI-biurets such as Desmodur® N 100 and N 3200 (from Bayer), Tolonate® HDB and HDB-LV (from Rhodia) and Duranate® 24A-100 (from Asahi Kasei); HDI-isocyanurates such as Desmodur® N 3300, N 3600 and N 3790 BA (from Bayer), Tolonate® HDT, HDT-LV and HDT-LV2 (from Rhodia), Duranate® TPA-100 and THA-100 (from Asahi Kasei) and Coronate® HX (from Nippon Polyurethane); HDI-uretdiones such as Desmodur® N 3400 (from Bayer); HDI-iminooxadiazinediones, such as Desmodur® 3900 (from Bayer); HDI-allophanates such as Desmodur® VP LS 2102 (from Bayer) and Basonat® HA 100, Basonat® HA 200 and Basonat® HA 300 (all from BASF); IPDI-isocyanurates, such as Desmodur® Z 4470 (from Bayer) and Vestanat® T1890/100 (from Evonik); mixed isocyanurates based on IPDI/HDI, such as Desmodur® NZ 1 (from Bayer); TDI-oligomers, such as Desmodur® IL (from Bayer); isocyanate-functional polyurethane polymers based on TDI, IPDI or HDI;
blocked amine hardeners other than aldimines of the formula (I) and (II);
organic solvents, such as hydrocarbons, esters or ethers, particularly acetyl acetone, mesityloxide, cyclohexanone, methylcyclohexanone, ethyl acetate, propyl acetate, 1-methoxy-2-propylacetate, butyl acetate, diethyl malonate, diisopropylether, diethylether, dibutylether, ethylene glycol diethylether, diethylene glycol diethylether, toluene, xylenes, heptanes, octanes, diisopropylnaphthalenes and petroleum fractions, such as naphtha, white spirits and petroleum ethers, such as Solvesso™ solvents (from Exxon), hydrogenated aromatic solvents such as hydrogenated naphtha, methylene chloride, propylene carbonate, butyrolactone, N-methyl-pyrrolidone and N-ethyl-pyrrolidone;
metal-based catalyst accelerating the reaction of the isocyanate groups, particularly dialkyltin complexes, particularly dimethyltin, dibutyltin or dioctyltin carboxylates, mercaptides or acetoacetonates, such as DMTDL, DBTDL, DBT(acac)₂, DOTDL, dioctyltin(IV)neodecanoate or DOT(acac)₂, bismuth(III) complexes, such as bismuth(III)octoate or bismuth(III)neodecanoate, zinc(II) complexes, such as zinc(II)octoate or zinc(II)neodecanoate, and zirconium(IV) complexes, such as zirconium(IV)octoate or zirconium(IV)neodecanoate;
additives, such as wetting agents, flow enhancers, levelling agents, defoamers, deaerating agents, drying agents, antioxidants, adhesion promoters, rheology modifiers, particularly fumed silica, and biocides.

When using such further ingredients it is advantageous to ensure that they do not strongly impair the shelf life stability of the uncured membrane, i.e. do not massively trigger reactions leading to crosslinking of the polymer during storage. In particular these further ingredients should not contain any water above trace quantities. It can be advantageous to dry ingredients physically or chemically before use.

Preferably the liquid applied membrane comprises
at least one ingredient selected from the group consisting of inorganic fillers and pigments,
at least one UV-stabilizer, and
at least one ingredient selected from the group consisting of catalysts, plasticizers, solvents, flame-retarding plasticizers and flame-retarding fillers.

These further ingredients provide membranes with good shelf life stability, good workability, fast curing properties, high elongation and strength and good durability, which have good flame-retarding properties with incorporated flame-retarding ingredients. Such membranes are highly suitable for applications on a roof.

Preferably the liquid applied membrane has a filler content in the range of 20 to 80 weight-%, more preferably in the range of 30 to 60 weight-%, the filler including pigments, inorganic, organic and flame-retarding fillers. At this filler content the membrane provides high strength and durability.

A particularly preferred liquid applied membrane contains
from 15 to 70 weight-% isocyanate-functional polyurethane polymer;
from 20 to 80 weight-% fillers including inorganic fillers, flame-retarding fillers and pigments;
from 5 to 30 weight-% plasticizers including flame-retarding plasticizers;
and comprises at least one further ingredient selected from the group consisting of catalysts, solvents and UV-stabilizers.

Such a membrane has good shelf life stability, good workability at low solvent content, good mechanical properties and good durability.

Preferably the liquid applied membrane has a low viscosity. This enables a good workability when applied as a self-levelling coating. Particularly the liquid applied membrane has a Brookfield viscosity in the range of 2'000 to 15'000 mPa·s at 20° C., preferably in the range of 2'000 to 10'000 mPa·s at 20° C. In this viscosity range the membrane is self-levelling enough to allow easy application on flat or low slope roof surfaces but does not flow away into small cavities on the substrate surface.

Preferably the liquid applied membrane has a low solvent content.

Preferably the liquid applied membrane contains less than 200 g VOC per liter, more preferably less than 100 g VOC per liter, and most preferably less than 65 g VOC per liter.

A further subject of the invention is the use of at least one aldimine of the formula (II) to increase strength and cure speed of a one-part moisture-curing liquid applied waterproofing membrane comprising at least one isocyanate-functional polyurethane polymer obtained from at least one polyether polyol and methylene diphenyl diisocyanate (MDI) and at least one aldimine of the formula (I).

Preferably the aldimine of the formula (II) is used in an amount corresponding to a molar ratio between the aldimine of the formula (I) and the aldimine of the formula (II) in the range of 90/10 to 60/40.

This use provides liquid applied membranes having a low viscosity at low solvent content, good shelf life stability, fast curing properties, high elongation and high strength in a broad temperature range, and good durability.

The one-part moisture-curing liquid applied waterproofing membrane may be prepared by mixing all ingredients under exclusion of moisture to obtain a homogeneous fluid. It may be stored in a suitable moisture-tight container, particularly a bucket, a drum, a hobbock, a bag, a sausage, a cartridge, a can or a bottle.

The membrane is applied in liquid state within its open time, typically by pouring it onto the substrate, followed by spreading it, e.g. with a roller or a squeegee, to get the desired layer thickness, which is typically in the range of 0.5 to 3 mm, particularly 0.75 to 1.5 mm.

“Open time” means hereby the period of time between the exposure to moisture and the formation of a skin on the surface of the membrane, also called “tack-free time” or “skinning time”.

The liquid applied membrane is self-levelling, which means its viscosity is low enough to develop an even surface after being spread by rolling or brushing.

The curing of the membrane starts when it gets in contact with moisture, typically atmospheric moisture. The curing process works by chemical reaction. The aldimino groups are activated with moisture and then react with isocyanate groups. On activation, each aldimino group forms a primary amino group. Furthermore, the isocyanate groups can also react directly with moisture. As a result of these reactions, the membrane cures to a solid, elastic material. The curing process may also be called crosslinking. After curing, an elastic material with a very good adhesion to a large number of substrates is obtained.

In the course of the curing reaction, the blocking agents of the aldimines, which are aldeyhdes of the formula (IV), are released. They are of low volatility and have little odour or are odourless. This enables membranes with no or little odour, emission and low shrinkage. The preferred aldimines of the formula (I) and (II) release 2,2-dimethyl-3-lauroyloxypropanal, which is completely odourless and remains almost completely in the cured membrane, being compatible with the crosslinked polyurethane polymer and acting as a plasticizer.

The liquid applied membrane can be applied onto various substrates, forming an elastic coating on the substrate. It can be used particularly for waterproofing a roof, a roof deck or a roof garden, as well as a planter, a balcony, a terrace, a plaza, or a foundation. It can also be used indoors for waterproofing, particularly under ceramic tiles, e.g. in a bath room, a catering kitchen or a plant room, protecting them from water ingress. The liquid applied membrane is particularly suitable for refurbishment purposes.

Most preferred is the use of the liquid applied membrane on a roof, particularly a flat or low slope roof. It can be used to waterproof a new roof as well as for refurbishment purposes and is particularly useful for detailing work.

The liquid applied membrane is preferably used as part of a waterproofing system, consisting of
optionally a primer and/or an undercoat,
one or more than one layers of the membrane, preferably in combination with a fibre reinforcement mesh, and
preferably a UV-resistant top coat.

The liquid applied membrane is preferably used by being poured onto a substrate, being spread evenly within its open time to the desired layer thickness, typically in the range of 0.5 to 3 mm, particularly in the range of 0.75 to 1.5 mm, e.g. with a roller, a squeegee, a spreading knife or a wiper.

Preferably the fibre reinforcement mesh is applied after the first layer of the membrane, by placing it on top of the freshly applied membrane and then rolling or working it thoroughly into the membrane within the open time of the membrane, particularly by means of a roller or a brush. The membrane with the incorporated fibre reinforcement mesh is then cured at least to the point that it can be walked on, before an optional next layer of the membrane is applied.

It is preferred to apply a top coat onto the top layer of the membrane, such as a covering lacquer or the like. Particularly preferred is the application of a UV-resistant top coat to enable a waterproofing system with very high durability, particularly against strong sunlight irradiation.

Another subject of the invention is a method of waterproofing a roof structure, comprising
applying the membrane in liquid state onto a substrate of the roof structure in a layer thickness in the range of 0.5 to 3 mm, particularly in the range of 0.75 to 1.5 mm;
contacting the membrane with a fibre reinforcement mesh within the open time of the membrane;
exposing the membrane to moisture to thereby cure the membrane partially or fully to obtain an elastic coating;
optionally applying a second layer of the membrane in a layer thickness in the range of 0.5 to 3 mm, particularly in the range of 0.75 to 1.5 mm, and curing it by exposure to moisture; and
preferably applying a UV-resistant top-coat.

The fibre reinforcement mesh is preferably a non-woven polyester fibre mesh and more preferably a non-woven glass fibre mesh.

The fibre reinforcement mesh acts as a reinforcement for the membrane, providing increased strength and durability. The randomly orientated fibres in the preferred non-woven fibre meshes give a multidirectional strength to the membrane while allowing it to remain highly elastic. It improves strength, tear resistance and puncture resistance. The non-woven glass fibre mesh shows a particularly easy handling, as it is not stiff, but easily adapts to the given surface topography.

Substrates onto which the membrane can be applied are particularly
concrete, lightweight concrete, mortar, brick, adobe, tile, slate, gypsum and natural stone, such as granite or marble;
metals and alloys, such as aluminium, copper, iron, steel, nonferrous metals, including surface-finished metals and alloys, such as galvanized metals and chrome-plated metals;
asphalt;
bituminous felt;
plastics, such as PVC, ABS, PC, PA, polyester, PMMA, SAN, epoxide resins, phenolic resins, PUR, POM, PO, PE, PP, EPM, EPDM in untreated form or surface treated by means of plasma, corona or flame; particularly PVC, PO (FPO, TPO) or EPDM membranes;
coated substrates, such as varnished tiles, painted concrete and coated metals.

It can be advantageous to pre-treat the substrate before applying the membrane, for example by washing, pressure-washing, wiping, blowing off, grinding and/or applying a primer and/or an undercoat.

By this method, a waterproof roof structure is obtained comprising the cured membrane with the incorporated fibre reinforcement mesh.

The roof structure is preferably part of the roof of a building, particularly a building from structural and civil engineering, preferably a house, an industrial building, a hangar, a shopping center, a sports stadium or the like.

The one-part moisture-curing liquid applied waterproofing membrane described herein has a series of advantages. It has a low odour or is odourless. It has a long shelf life stability and a low viscosity at low solvent content, even when containing only about 200 g VOC per liter or less. Being a one-part system, there is no mixing step required, which facilitates application. It has a sufficiently long open time to allow hand application, making the use of special equipment such as spraying machines unnecessary. Preferably the open time is at least 30 minutes, more preferably at least 40 minutes at room temperature and 50% relative humidity. When contacted with moisture, the membrane cures fast to a solid walkable material. In order not to be vulnerable for too long after application, the open time should, on the other hand, not be too long. Preferably, the open time is not longer than 70 minutes, more preferably not longer than 60 minutes at room temperature and 50% relative humidity. After full curing, the membrane is an elastic material having high strength and elongation in a broad temperature range, as well as good durability.

At 23° C., the membrane preferably has a tensile strength of at least 3.0 MPa, more preferably at least 3.5 MPa, an elongation at break of at least 300%, more preferably at least 400%, and a Shore A hardness of at least 50.

At −20° C., the membrane preferably has an elongation at break of at least 300%, more preferably at least 400%.

At 60° C., the membrane preferably has a tensile strength of at least 1.5 MPa, more preferably at least 2.0 MPa, and an elongation at break of at least 150%, more preferably at least 200%, particularly at least 250%.

With these mechanical properties the membranes fulfill the Japanese standard JIS-6021 for waterproofing membranes.

### Examples

“Normal climate” means a temperature of 23±1° C. and a relative atmospheric moisture of 50±5%.

The amine content (total content of free amines and blocked amines, i.e. aldimino groups) of the prepared aldimines was determined by titration (with 0.1 N HClO₄ in acetic acid against cristal violet) and is given in mmol N/g.

### 1. Preparation of Aldimines

### Aldimine-1: N,N′-bis(2,2-dimethyl-3-lauroyloxypropylidene)-3-aminomethyl-3,5,5-trimethylcyclohexylamin

598 g (2.1 mol) 2,2-dimethyl-3-lauroyloxy-propanal were placed in a round bottom flask under nitrogen atmosphere. Then 170.3 g (1 mol) 3-aminomethyl-3,5,5-trimethylcyclohexylamine (Vestamin® IPD from Evonik) were added under good stirring, followed by removing the volatile contents at 80° C. and 10 mbar vacuum. The yield was 732 g of a nearly colourless liquid with an amine content of 2.73 mmol N/g, corresponding to a calculated aldimine equivalent weight of approx. 367 g/Eq.

### Aldimine-2: N,N′-bis(2,2-dimethyl-3-lauroyloxypropylidene)-hexamethylene-1,6-diamine

Under the same conditions as given for Aldimine-1, 622 g (2.2 mol) 2,2-dimethyl-3-lauroyloxy-propanal and 166.0 g (1 mol) hexamethylene-1,6-diamine solution (70 weight-% in water) were reacted. The yield was 702 g of a nearly colourless liquid with an amine content of 2.85 mmol N/g, corresponding to a calculated aldimine equivalent weight of approx. 351 g/Eq.

### 2. One-Part Moisture-Curing Liquid Applied Membranes

For each membrane the ingredients given in Table 1 were mixed under exclusion of moisture in a sealed polypropylene beaker by means of a centrifugal mixer (SpeedMixer™ DAC 150, FlackTek Inc.) until a homogeneous fluid was obtained.

The membranes were stored in a tightly sealed, moisture-proof can for 24 hours at ambient temperature and then tested as follows:

Viscosity was measured with a BH type viscometer, n^{o} 4 rotor, 20 rpm, at a temperature of 23° C. (Brookfield viscosity). “Initial” means the viscosity measured 24 hours after mixing of the ingredients. “28 d 40° C.” means the viscosity measured after an additional storage of 28 days at 40° C.

To determine the tack-free time (time until a tack-free skin has developed on the applied membrane, also called “open time”) a small portion of the membrane was applied in normal climate in a layer of 2 mm on cardboard and touched slightly with an LDPE pipette until the membrane stopped to leave a residue on the surface of the pipette.

Shore A hardness was measured according to DIN 53505 with a specimen of 10 mm thickness, which was cured in normal climate for 7 days.

To determine the mechanical properties, a film of 2 mm thickness, which was cured for 7 days in normal climate, was prepared. Dumbbells with a length of 100 mm, a crosspiece length of 20 mm and a crosspiece width of 5 mm were punched from the cured free film and measured for tensile strength, elongation at break and tear strength according to JIS A6021 at 23° C., at −20° C. and at 60° C.

To determine durability, some of the dumbbells were exposed to the following storage conditions: in an oven at 80° C. for 168 hours (“80° C. storage”); soaked in 20° C. aqueous 0.1 wt % NaOH saturated with Ca(OH)₂ for 168 hours, then washed with water and wiped with a dry cloth (“alkali storage”); soaked in 20° C. waterbased 2 wt % sulfuric acid for 168 hours, then washed with water and wiped with a dry cloth (“acid storage”); for 250 hours in a sunshine carbon arc weather′o′meter as described in JIS A 1415 (“WOM storage”). After each storage, the dumbbells were kept in normal climate for one day before measuring tensile strength and elongation at break at 23° C. as already described.

All the liquid applied membranes formed flexible films without bubbles and without tack.

The results are given in Table 2.

The liquid applied membranes Ex-1 and Ex-2 are examples according to the invention, the liquid applied membranes Ref-1 and Ref-2 are comparative examples.

The Polymer-1 was prepared by reacting 843.4 g ethylene oxide end-capped polyoxypropylene diol with an average molecular weight of 3000 g/mol, 495.0 g polyoxypropylene triol with an average molecular weight of 3000 g/mol, 266.5 of 4,4′-diphenylmethane diisocyanate and 61.9 g carbodiimide-modified 4,4′-diphenylmethane diisocyanate (isocyanate content of 29 weight-%, Cosmonate® LL from Mitsui Chemicals) according to known procedures at 80° C. to obtain an isocyanate-functional polyurethane polymer with an isocyanate content of 3.8 weight-%.

Aldimine-1 is N,N′-bis(2,2-dimethyl-3-lauroyloxypropylidene)-3-aminomethyl-3,5,5-trimethylcyclohexylamine with an equivalent weight of 367 g/Eq.

Aldimine-2 is N, N′-bis(2,2-dimethyl-3-lauroyloxypropylidene)-hexamethylene-1,6-diamine with an equivalent weight of 351 g/Eq.

TABLE 1
Composition (in weight parts) of the
examples Ex-1, Ex-2, Ref-1 and Ref-2

| | Ref-1 | Ex-1 | Ex-2 | Ref-2 |
|---|---|---|---|---|
| Polymer-1 | 35.1 | 35.1 | 35.1 | 35.1 |
| Diisononyl phthalate | 8.8 | 8.8 | 8.8 | 8.8 |
| HALS ¹ | 0.3 | 0.3 | 0.3 | 0.3 |
| Titanium dioxide | 0.5 | 0.5 | 0.5 | 0.5 |
| Ground calcium carbonate | 34.0 | 29.0 | 25.0 | 25.0 |
| Stearate-coated calcium carbonate | 10.0 | 10.0 | 20.0 | 20.0 |
| Solvent ² | 8.2 | 10.0 | 4.0 | 4.0 |
| Aldimine-1 | 3.0 | 4.0 | 5.0 | 6.1 |
| Aldimine-2 | 3.0 | 2.1 | 1.1 | — |
| Molar Ratio Aldimine-1/Aldimine-2 | 49/51 | 65/45 | 81/19 | 100/0 |
| VOC Content [g/l] | 105 | 126 | 55 | 55 |

¹ bis-(1,2,2,6,6-pentamethyl-4-piperidyl)-sebacate
² alicyclic hydrocarbon mixture

TABLE 2
Test results of the examples Ex-1, Ex-2, Ref-1 and Ref-2

| | | Ref-1 | Ex-1 | Ex-2 | Ref-2 |
|---|---|---|---|---|---|
| Viscosity [mPa · s], initial | | 6500 | 5760 | 7′520 | 7′450 |
| Viscosity (23° C.) [mPa · s], | | 7800 | 7200 | 9′020 | 8′900 |
| 28 d 40° C. | | | | | |
| Tack-Free Time [min] | | 30 | 50 | 50 | 90 |
| Shore A | | 69 | 66 | 56 | 50 |
| Tensile Strength [MPa] (at 23° C.) | | 3.6 | 3.5 | 3.1 | 2.8 |
| Elongation at Break [%] (at 23° C.) | | 275 | 550 | 570 | 610 |
| Tear Strength [N/mm] (at 23° C.) | | 21.0 | 18.5 | 14.4 | 11.4 |
| Tensile Strength [MPa] (at −20° C.) | | n.d. | 9.6 | 9.5 | n.d. |
| Elongation at Break [%] (at −20° C.) | | | 420 | 420 | |
| Tensile Strength [MPa] (at 60° C.) | | n.d. | 1.9 | 2.1 | n.d. |
| Elongation at Break [%] (at 60° C.) | | | 170 | 260 | |
| 80° C. | Tensile Strength [MPa] | n.d. | 3.9 | 3.4 | n.d. |
| Storage: | Elongation at Break [%] | | 550 | 550 | |
| Alkali | Tensile Strength [MPa] | n.d. | 3.0 | 2.6 | n.d. |
| Storage: | Elongation at Break [%] | | 520 | 530 | |
| Acid | Tensile Strength [MPa] | n.d. | 3.0 | 2.7 | n.d. |
| Storage: | Elongation at Break [%] | | 500 | 520 | |
| WOM | Tensile Strength [MPa] | n.d. | 3.0 | 2.6 | n.d. |
| Storage: | Elongation at Break [%] | | 550 | 530 | |

“n.d.” means _{”}not determined”

1. A one-part moisture-curing liquid applied waterproofing membrane comprising
at least one isocyanate-functional polyurethane polymer obtained from at least one polyether polyol and methylene diphenyl diisocyanate (MDI);
at least one aldimine of the formula (I); and
at least one aldimine of the formula (II), 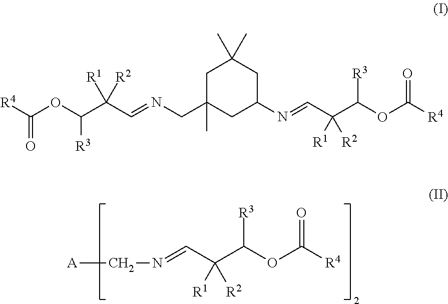
wherein
R1 and R2 are the same or different C1 to C12 linear or branched alkyls, or are joined together to form a divalent linear or branched C4 to C12 hydrocarbyl moiety which is part of a 5-to 8-membered carbocyclic ring,
R3 is hydrogen or a linear or branched C1 to C12 alkyl or arylalkyl or alkoxycarbonyl,
R4 is a monovalent C6 to C20 hydrocarbyl moiety optionally containing ether, carbonyl or ester groups, and
A is nil or a divalent hydrocarbyl moiety of a molecular weight in the range of 14 to 140 g/mol;
whereby the molar ratio between the aldimine of the formula (I) and the aldimine of the formula (II) is in the range of 90/10 to 60/40.

2. The membrane according to claim 1, wherein the polyurethane polymer has a free isocyanate group content of below 5 weight-%.

3. The membrane according to claim 1, wherein the polyether polyol is a polymerization product of ethylene oxide and/or propylene oxide.

4. The membrane according to claim 1, wherein A is a 1,4-butylene or an 1,3-cyclohexylene or an 1,3-phenylene group.

5. The membrane according to claim 1, wherein the aldimine of the formula (I) is N,N′-bis(2,2-dimethyl-3-lauroyloxypropylidene)-3-aminomethyl-3,5,5-trimethylcyclohexylamine.

6. The membrane according to claim 1, wherein the aldimine of the formula (II) is N,N′-bis(2,2-dimethyl-3-lauroyloxypropylidene)-hexamethylene-1,6-diamine.

7. The membrane according to claim 1 further comprising
at least one ingredient selected from the group consisting of inorganic fillers and pigments,
at least one UV-stabilizer, and
at least one ingredient selected from the group consisting of catalysts, plasticizers, solvents, flame-retarding plasticizers and flame-retarding fillers.

8. The membrane according to claim 1 containing
from 15 to 70 weight-% isocyanate-functional polyurethane polymers;
from 20 to 80 weight-% fillers including inorganic fillers, flame-retarding fillers and pigments;
from 5 to 30 weight-% of plasticizers including flame-retarding plasticizers;
and comprising at least one further ingredient selected from the group consisting of catalysts, solvents and UV-stabilizers.

9. The membrane according to claim 1 having a Brookfield viscosity in the range of 2'000 to 15'000 mPa·s at 20° C.

10. The membrane according to claim 1 containing less than 200 g VOC per liter.

11. Use of the membrane according to claim 1 on a roof.

12. Waterproofing system, consisting of
optionally a primer and/or an undercoat,
one or more than one layers of the membrane according to claim 1, preferably in combination with a fibre reinforcement mesh, and
preferably a UV-resistant top coat.

13. Method of waterproofing a roof structure, comprising
applying the membrane according to claim 1 in liquid state onto a substrate of the roof structure in a layer thickness in the range of 0.5 to 3 mm;
contacting the membrane with a fibre reinforcement mesh within the open time of the membrane;
exposing the membrane to moisture to thereby cure the membrane partially or fully to obtain an elastic coating,
optionally applying a second layer of the membrane in a layer thickness in the range of 0.5 to 3 mm and curing it by exposure to moisture; and
preferably applying a UV-resistant top-coat.

14. Waterproof roof structure, obtained by the method according to claim 13.

15. Use of at least one aldimine of the formula (II) to increase strength and cure speed of a one-part moisture-curing liquid applied waterproofing membrane comprising at least one isocyanate-functional polyurethane polymer obtained from at least one polyether polyol and methylene diphenyl diisocyanate (MDI) and at least one aldimine of the formula (I), 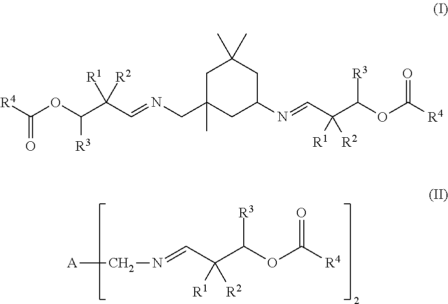
wherein
R1 and R2 are the same or different C1 to C12 linear or branched alkyls, or are joined together to form a divalent linear or branched C4 to C12 hydrocarbyl moiety which is part of a 5-to 8-membered carbocyclic ring,
R3 is hydrogen or a linear or branched C1 to C12 alkyl or arylalkyl or alkoxycarbonyl,
R4 is a monovalent C6 to C20 hydrocarbyl moiety optionally containing ether, carbonyl or ester groups, and
A is nil or a divalent hydrocarbyl moiety of a molecular weight in the range of 14 to 140 g/mol.
